(19) United States
(12) Patent Application Publication
(10) Pub. No.: US 2026/0031628 A1
(43) Pub. Date: Jan. 29, 2026

(54) MULTI-FUNCTIONAL POWER CONVERSION UNITS FOR RECREATIONAL VEHICLES PROVIDING BI-DIRECTIONAL ELECTRICAL POWER

(71) Applicant: Thor Tech, Inc., Elkhart, IN (US)

(72) Inventors: James Kane, Detroit, MI (US); Simon Wespel, Elkhart, IN (US); Jeffrey Patterson, Elkhart, IN (US); Alexander Chrisman, Elkhart, IN (US)

(73) Assignee: Thor Tech, Inc., Elkhart, IN (US)

(21) Appl. No.: 19/278,122

(22) Filed: Jul. 23, 2025

Related U.S. Application Data
(60) Provisional application No. 63/674,992, filed on Jul. 24, 2024.
(60) Provisional application No. 63/674,987, filed on Jul. 24, 2024.

(51) Int. Cl. H02J 3/32; B60L 53/20; B60L 53/51; B60L 55/00; B60L 58/12; H02J 7/00; H02J 7/35; H02M 3/00; H02S 10/20; H02S 20/30

(52) U.S. Cl. CPC H02J 3/322; B60L 53/20; B60L 53/51; B60L 55/00; B60L 58/12; H02J 7/00712; H02J 7/35; H02M 3/003; H02S 10/20; H02S 20/30; B60L 2210/10; H02J 2207/20

(57) ABSTRACT

A recreational vehicle (RV) includes a battery module that is charged when the RV battery module has a state of charge below a threshold and voltage is received at one or more of an RV AC input receptacle and a bi-directional receptacle, or voltage is received at a solar module. AC voltage is provided at an AC outlet receptacle to power one or more of a grid and a building when the battery module has a state of charge above a threshold and voltage is received at one or more of the RV AC input receptacle and the bi-directional receptacle, or DC voltage is received at the solar module. AC voltage is provided at the AC outlet receptacle to power the building when the battery module has a state of charge above a threshold and no voltage is received at the RV AC input receptacle or the RV bi-directional receptacle.

### CROSS-REFERENCE TO RELATED APPLICATIONS

This application claims priority to U.S. Provisional Patent Application No. 63/674,992 filed on Jul. 24, 2024 and entitled “RV POWER SYSTEMS PROVIDING BI-DIRECTIONAL POWER,” and to U.S. Provisional Patent Application No. 63/674,987 filed on July 24, 204 and entitled “SCALABLE RV POWER MANAGEMENT SYSTEM.”

### BACKGROUND

Properties such as homes, office buildings, government buildings, educational buildings, recreational spaces, farms and the like are typically electrically powered by an electrical grid whereby electrical power is provided by a power generation utility. While electrical power is usually consistent and reliable, there are instances where electrical power service is interrupted, such as due to a storm, repairs to grid components, or brown-out situations. Properties may utilize backup power systems, such as generators and battery backup systems. These backup power systems are operable to provide AC power to the property when electrical power from the grid is unavailable. However, such backup power systems are complicated and expensive. Generators require expensive fuel and upkeep, are loud, and generate undesirable fumes during operation. Battery backup systems require expensive inverters to convert the DC power of the battery to AC output needed to be applied to the circuit breaker panel of the property to power.

A recreational vehicle (RV) has a battery module to provide electrical power to the RV when the RV is not connected to an external AC power source, which is often called “shore power.” Various loads of the RV may operate on DC power (e.g., 12 VDC). The RV may also have an inverter that converts the DC power of the battery to AC power so that the RV can power AC loads, such as loads connected to AC receptacles of the RV. However, disparate components, such as inverters, converters, solar modules, are large and bulky, and therefore take up significant space in an RV, which is at a premium as manufacturers desire to maximize living space in RV to improve comfort and functionality.

Additionally, during many parts of the year, the RV is not in use and is being stored at a property, such as an owner's home. For example, the RV may only be used on weekends or weeklong vacations.

Accordingly, alternative power modules and functionalities for leveraging a battery module of an RV when the RV is not in use may be desired.

### BRIEF SUMMARY

Embodiments of the present disclosure enable a recreational vehicle (RV) to be a power source for a property, such as a backup power system or a supplemental power source. More particularly, the embodiments of the present disclosure leverage the battery and inverter module of the RV to act as a backup power source when the RV is not in use, plugged into a home's electrical system, and there is a grid failure. Embodiments also allow the solar panels of the RV to provide supplemental power to the home. A bi-directional charger allows AC and/or DC power to be bi-directionally provided between the home and the RV. The embodiments of the present disclosure enhance the functionality of the RV as a power source, particularly when the RV is in storage at the owner's home.

RVs encompassed by the present disclosure include motorized recreational vehicles, like motor homes and other vehicles with their own motor and drivetrain, and include trailer-type recreational vehicles, which include fifth wheel trailers and other types of towable campers, toy haulers, etc. It is noted that while the present disclosure specifically references RVs, the present disclosure may also be applied to any vehicle including a battery.

A recreational vehicle (RV) includes an RV battery module that provides a direct current (DC) voltage of 400 volts or greater, an RV alternating current (AC) input receptacle for receiving AC voltage from an external source, an RV AC outlet receptacle for providing AC voltage to one or more of a grid and a building, an RV bi-directional receptacle for receiving voltage from an external source and providing voltage to an external load; and a power conversion unit having a housing enclosing a plurality of slots operable to removably receive a plurality of power modules, wherein the plurality of power modules includes a solar module operable to receive DC voltage from one or more solar panels and convert the DC voltage to a second DC voltage, a charger module operable to convert AC voltage into DC voltage to charge the RV battery module, and an inverter module operable to convert DC voltage provided by the RV battery module into AC voltage that powers one or more RV AC loads and is provided at one or more of the RV AC outlet receptacle and the RV bi-directional receptacle. The RV battery module is charged by the charger module when the RV battery module has a state of charge below a threshold and voltage is received at one or more of the RV AC input receptacle and the RV bi-directional receptacle, or DC voltage is received at the solar module, the RV battery module is charged by the charger module. AC voltage is provided at the RV AC outlet receptacle to power one or more of the grid and the building when the RV battery module has a state of charge above a threshold and voltage is received at one or more of the RV AC input receptacle and the RV bi-directional receptacle, or DC voltage is received at the solar module. AC voltage is provided at the RV AC outlet receptacle to power the building when the RV battery module has a state of charge above a threshold and no voltage is received at the RV AC input receptacle or the RV bi-directional receptacle.

A power conversion unit for a recreational vehicle (RV), the power conversion unit including a housing enclosing a plurality of slots operable to removably receive a plurality of power modules. The plurality of power modules includes a solar module operable to receive DC voltage from one or more solar panels and convert the DC voltage to a second DC voltage, a charger module operable to convert AC voltage into DC voltage to charge the RV battery module, and an inverter module operable to convert DC voltage provided by the RV battery module into AC voltage that powers one or more RV AC loads and is provided at one or more of the RV AC outlet receptacle and the RV bi-directional receptacle. The charger module of the power conversion unit is operable to charge an RV battery module of the RV when the RV battery module has a state of charge below a threshold and AC voltage is received by the charger module, or DC voltage is received at the solar module. AC voltage is provided by the inverter module to power one or more of a grid and a building when the RV battery module has a state of charge above a threshold and AC voltage is received at the charger module, or DC voltage is received at the solar module. AC voltage is provided by the inverter module to power the building when the RV battery module has a state of charge above a threshold and no voltage is received by the charger module.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example recreational vehicle power system according to one or more embodiments described and illustrated herein.

FIG. 2 illustrates a front perspective view of an example power conversion unit according to one or more embodiments described and illustrated herein.

FIG. 3 illustrates a front perspective view of the example power conversion unit of FIG. 2 with modules installed according to one or more embodiments described and illustrated herein.

FIG. 4 illustrates a rear perspective view of the example power conversion unit of FIG. 2 according to one or more embodiments described and illustrated herein.

FIG. 5 illustrates a rear elevation view of the example power conversion unit of FIG. 2 according to one or more embodiments described and illustrated herein.

FIG. 6 illustrates another a rear perspective view of the example power conversion unit of FIG. 2 according to one or more embodiments described and illustrated herein.

FIG. 7 illustrates a front perspective view of the example power conversion unit of FIG. 2 with a terminal box removed according to one or more embodiments described and illustrated herein.

FIG. 8 illustrates a front elevation view of the example power conversion unit of FIG. 2 with a terminal box removed according to one or more embodiments described and illustrated herein.

FIG. 9 illustrates an example living space of a recreational vehicle having a power conversion unit mounted under a bed, as well as a system control unit for interfacing with the power conversion unit according to one or more embodiments described and illustrated herein.

FIG. 10 illustrates an example state diagram of states of an electric RV according to one or more embodiments described and illustrated herein.

### DETAILED DESCRIPTION

Properties such as homes, office buildings, government buildings, educational buildings, recreational spaces, farms and the like are typically electrically powered by an electrical grid whereby electrical power is provided by a power generation company. While electrical power is usually consistent and reliable, there are instances where electrical power service is interrupted, such as due to a storm, repairs to grid components, or brown-out situations. Properties may utilize backup power systems, such as generators and battery backup systems. These backup power systems are operable to provide AC power to the property when electrical power from the grid is unavailable. However, such backup power systems are complicated and expensive. Generators require expensive fuel and upkeep, are loud, and generate undesirable fumes during operation. Battery backup systems require expensive inverters to convert the DC power of the battery to AC output needed to be applied to the circuit breaker panel of the property to power.

A recreational vehicle (RV) has a battery module to provide electrical power to the RV when the RV is not connected to an external AC power source, which is often called “shore power.” Various loads of the RV may operate on DC power (e.g., 12 VDC). The RV may also have an inverter that converts the DC power of the battery to AC power so that the RV can power AC loads, such as loads connected to AC receptacles of the RV.

During many parts of the year, the RV is not in use and is being stored at a property, such as an owner's home. For example, the RV may only be used on weekends or weeklong vacations.

Embodiments of the present disclosure enable the RV to be a power source for the property, such as a backup power system or a supplemental solar power source. Therefore, a separate expensive backup power system dedicated for the home does not need to be purchased. Transfer switches and controller logic enable the smart switching of bi-directional AC and/or DC power between the RV and the premise. As the RV includes one or inverter modules to convert the DC battery power to AC power, embodiments leverage these RV inverter modules to power the property such that expensive dedicated inverters are not needed to be installed at the property. Where RVs are equipped with solar panels, the electrical power generated by these solar panels may be used to directly provide power to the property, or to charge the RV battery depending on the current needs of the RV and property. Therefore, the RV may operate as a solar panel when it is being stored on the property. Even further, embodiments of the present disclosure enable the RV to be connected to auxiliary solar panels, such as solar panels installed at the property. RVs according to the present disclosure connect these auxiliary solar panels to a solar module for DC-DC conversion and then to either charge the RV battery, convert the DC solar power to AC power for providing AC power to the property, or passing DC solar power to the premise.

Embodiments further enable bi-directional power flow between the premise and RV by way of a bi-directional charger and bi-directional charger connector, such as a vehicle CCS connector. Therefore, not only can the charger connector charge the battery of the RV, the RV can also provide AC and/or DC power back to the property.

The RV power systems of the present disclosure include a power conversion unit that houses a plurality of different modules having different functions, such as solar modules, inverter modules, charger modules, and DC-DC converter modules. These modules can be swapped in and out of a common housing, providing flexibility to RV owners.

Various embodiments of RVs and RV power systems are described in detail below.

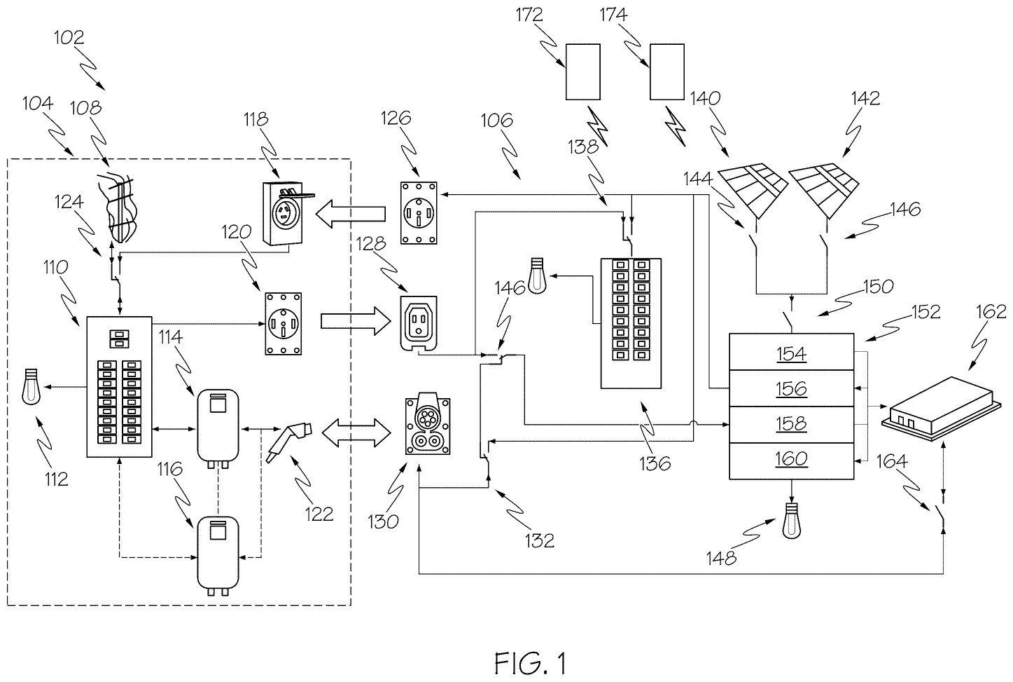

Referring now to FIG. 1, an example power system 102 employing an RV as backup power system for a home or other dwelling is schematically illustrated. The power system 102 generally includes a home 104 (or other property, such as an office space, a store, a recreation center, a government building, and the like) and an RV 106. As described in more detail below, the RV 106 is configured to provide flexible power needs to the home 104 using its on-board RV battery module 162 and power conversion unit (PCU 152).

The home 104 includes a panel 110 that receives AC power from the grid 108 under normal operating conditions. An input of the panel 110 is electrically coupled to an automatic home transfer switch 124 which is operable to switch the panel 110 between grid 108 power and backup power, such as backup power from the RV 106 as described in more detail below.

The home 104 further includes a home AC input receptacle 118 which is operable to receive AC power as input, such as from a generator, a backup battery, or an RV 106 as shown in FIG. 1. The home AC input receptacle 118 may be configured as a generator input receptacle, for example. The home AC input receptacle 118 is electrically coupled to a leg of the home transfer switch 124. When grid 108 power is unavailable, the home transfer switch 124 may automatically switch to the home AC input receptacle 118 such that the panel 110 may receive AC power from the RV 106 to provide electrical power to the home loads 112.

The panel 110 has a plurality of breakers for a plurality of circuits that power home loads 112, such as lights, heating and cooling systems, electronics, cooking appliances, home appliances, and the like.

The panel 110 further includes a circuit that is electrically coupled to a home AC output receptacle 120 that is operable to provide electrical power to the RV 106. As a non-limiting example, the home AC output receptacle 120 may be configured as a 50 A, 125V/250V receptacle operable to be electrically coupled to an RV AC input receptacle 128 by way of a cable assembly, as described in more detail below.

A bi-directional charger 114 is also provided at the home 104. The bi-directional charger 114 is operable to both provide AC power to the RV 106 as well as receive AC power from the RV 106 to provide AC power to the panel 110. The bi-directional charger 114 may be a Level 2 charger, for example. The bi-directional charger includes a bi-directional connector 122, such as a J1772 connector, a CCS connector, or a NASC connector as non-limiting examples. In some embodiments, the bi-directional charger 114 includes a converter circuit to convert the AC power from the grid 108 at the panel 110 into DC power to be provided on DC pins of the bi-directional connector. Additionally, DC power from the RV may be provided to the bi-directional charger 114 on the DC pins of the bi-directional connector 122. Thus, the bi-directional charger 114 is operable to both provide and receive AC or DC power to and from the RV 106.

The RV 106 includes an RV battery module 162 operable to provide DC power to various RV loads 134 of the RV 106, such as lights, heating and cooling systems, electronics, cooking appliances, home appliances, and the like. The RV battery module 162 may produce a DC voltage, such as 400V or 800V, for example.

An RV AC outlet receptacle 126 is provided on the RV 106 which is operable to be coupled to the home AC input receptacle 118 by way of a cable assembly (not shown). In the illustrated embodiment the RV AC outlet receptacle 126 is depicted as a female receptacle but embodiments are not limited thereto. The RV AC outlet receptacle 126 may configured as a generator receptacle, for example. As described in more detail below, the RV AC outlet receptacle 126 is operable to provide AC power to the home 104 when the RV 106 is operating as a backup power source.

An RV AC input receptacle 128 is also provided on the RV 106 which is operable to be coupled to the home AC output receptacle 120 by way of a cable assembly (not shown). In the illustrated embodiment the RV AC input receptacle 128 is depicted as a male receptacle but embodiments are not limited thereto. The RV AC input receptacle 128 is operable to receive AC power from the home 104, which is referred to herein as “shore power.” The RV AC input receptacle 128 may receive AC power from any AC source, such as the grid 108 or a generator. Shore power may be used to operate the various loads of the RV when the input receptacle 128 is connected to the home AC output receptacle 120 by a connectorized cord.

The RV 106 further includes an RV bi-directional receptacle 130 that is operable to receive the bi-directional connector 122 to either receive AC or DC power, or provide AC or DC power to the home 104, as described in more detail below.

In the illustrated embodiment the RV 106 is equipped with one or more RV solar panels 140 that generate DC power. The RV 106 also has the capability of being electrically connected to one or more auxiliary solar panels 142 that are not mounted to the RV 106. The auxiliary solar panel 142 may be positioned within a yard of a home, a roof of a home or other building, or some other location that is not on the RV 106. It should be understood that in some embodiments the RV 106 does not include RV solar panels 140 and/or does not have the capability of being electrically connected to auxiliary solar panels 142.

A multi-functional PCU 152 is also provided within the RV 106. The PCU 152 both receives input power from various sources, and converts and conditions power for both use by the RV 106 as well as by the home 104 when in a backup mode. The PCU 152 includes a housing having a plurality of slots for receiving modules having different functions, such as a solar module 154, an inverter module 156, a charger module 158, and a DC-DC converter module 160. The modules may be swapped in and out of the housing of the PCU 152 to provide expanded and flexible functionality for the RV 106.

The solar module 154 is operable to receive DC input voltage as generated by the RV solar panel 140 and/or the auxiliary solar panel 142 and convert the DC input voltage into a DC voltage for use by the other modules of the PCU 152, such as to charge the RV battery module 162. A PCU disconnect 150 is provided between the RV solar panel 140 and the auxiliary solar panel 142 to disconnect these components from the PCU 152. The solar power provided by the RV solar panels 140 and/or the auxiliary solar panels 142 may be converted to AC power by the inverter module 156 and provided at the RV AC outlet receptacle 126 for use by the home 104.

The PCU 152 includes input terminals (not shown) to receive DC voltage from the RV battery module 162, such as 400V or 800V, for example. This input voltage is provided to the various modules inserted into the PCU 152.

The inverter module 156 receives the input voltage from the RV battery module 162 and converts it an AC voltage that is provided to the RV panel 136 through the bypass transfer switch 138 when the RV 106 not receiving shore power. The inverter may generate a 120V AC power for use by the various RV loads 134 through the circuits of the RV panel 136.

The inverter module 156 provides AC power at the RV AC outlet receptacle 126 for use when the RV 106 is used as a backup power source to provide AC power to the home AC input receptacle 118. The inverter module 156 also provides AC power to the RV panel 136 when the RV 106 is not connected to shore power at the RV AC input receptacle 128. In such a scenario, the bypass transfer switch 138 is set to disconnect the RV panel 136 from the RV AC input receptacle 128, and connect the RV panel 136 to the inverter module 156 so that the AC power generated by the inverter module 156 is available to the various RV loads 134 by way of the RV panel 136.

The inverter module 156 also provides AC power at the RV bi-directional receptacle 130 when the bi-directional transfer switch 132 is switched to connect the RV bi-directional receptacle 130 to the inverter module 156. In this mode, the RV 106 exports AC power to home 104.

The charger module 158 includes a rectifier circuit that is operable to receive AC shore power from the RV AC input receptacle 128 and convert it into DC power to charge the RV battery module 162, such as 400 VDC or 800 VDC. During charging, the shore power transfer switch 146 is set to receive AC power from either the RV AC input receptacle 128 or the RV bi-directional receptacle 130. The power system 102 detects which receptacle among the RV AC input receptacle 128 and the RV bi-directional receptacle 130 is connected to shore power. For example, a controller (not shown) may monitor the input receptacle 128 and the bi-directional receptacle 130 to determine which is connected. If both are connected, the controller may select the bi-directional receptacle 130 as the primary input because this input can provide more electrical power than the RV AC input receptacle 128. However, the prioritization between the bi-directional receptacle 130 and the RV AC input receptacle 128 may be established by the use in customizable settings. It is also noted that in some embodiments the system can determine whether the bi-directional receptacle 130 is providing Level 1 power and, if so, select the RV AC input receptacle 128 when the RV AC input receptacle 128 can provide more electrical power.

When shore power is being provided at the RV AC input receptacle 128, the shore power transfer switch 146 is switched to electrically couple the RV AC input receptacle 128 to the charger module 158 so that the RV battery module 162 is charged by shore power received from the RV AC input receptacle 128. When shore power is being provided at the RV bi-directional receptacle 130, the bi-directional transfer switch 132 and the shore power transfer switch 146 are switched to electrically couple the RV bi-directional receptacle 130 to the charger module 158 so that the RV battery module 162 is charged by shore power received from the RV bi-directional receptacle 130.

The DC-DC converter module 160 receives DC voltage from the RV battery module 162 (e.g., 400V or 800V) and converts it into another voltage, such as 12 VDC. It is common for RVs to have 12V loads, such as 12V lights and 12V accessories. Thus, the DC-DC converter module 160 is electrically coupled to various RV DC loads 148.

The RV 106 may also be capable of offboarding DC power to the home 104. The illustrated power system 102 includes a DC offboarding contact switch 164 that provides battery DC voltage from the RV battery module 162 (e.g., 400 VDC or 800 VDC) to the DC power pins of the RV bi-directional receptacle 130, which may be a CCS receptacle having the two lower DC power pins. When in a DC offboarding mode, the DC offboarding contact switch 164 is turned on, and DC power is provided to a DC converter/charger 116 at the home 104. The DC converter/charger 116 includes an inverter that is operable to receive the DC voltage from the RV battery module 162 and generate AC power that is then provided to the home panel 110 for use by the home loads 112.

Embodiments of the present disclosure includes one or more controllers to determine the needs of the power system 102 and activate the various switches accordingly. For example, when the RV 106 is plugged into shore power at the RV AC input receptacle 128, the shore power transfer switch 146 is switched to connect the RV AC input receptacle 128 to the charger module 158 to provide shore power thereto. Additionally, the bypass transfer switch 138 is switched to connect the RV AC input receptacle 128 to the RV panel 136 such that the RV loads 134 and the RV DC loads 148 are powered using shore power.

During normal operation, the bypass transfer switch 138 is in a position where the RV panel 136 is powered by the inverter module 156, even when the RV is connected to shore power. When the one or more controllers sense and interruption of shore power (e.g., the RV battery module 162 does not have enough charge or there is a problem with the inverter module 156), the bypass transfer switch 138 and the shore power transfer switch 146 switch to a bypass mode such that the RV panel 136 is powered by shore power, such as from power received by the RV AC input receptable 128.

When there is an interruption of grid power from the grid 108, the RV 106 can provide power to the home. In this situation, the home transfer switch 124 is switched to connect the home AC input receptacle 118 to the home AC input receptacle 118, which receives backup AC power from the RV 106 at the RV AC outlet receptacle 126. Backup AC power from the RV 106 may also be provided at the RV bi-directional receptacle 130 by the switching of the bi-directional transfer switch 132 to connect the RV bi-directional receptacle 130 to the inverter module 156.

When there is no connector plugged into the RV AC input receptacle 128 but there is a connector plugged into the RV bi-directional receptacle 130 that is providing AC power, the one or more controllers switch the bi-directional transfer switch 132 into a charge mode whereby RV bi-directional receptacle 130 is connected to the charger module 158.

Embodiments further include logic as to when and how to best route solar power through the RV 104 based on a desired state of charge (SOC) for the RV battery module 162. In one scenario when a user enters a desired SOC for the RV battery module 162 and a period of time that the RV 106 will be parked at the home 104 into the control system, the power system 102 will charge the RV battery module 162 to the desired SOC using solar by the end of the entered period of time, and provide power to the home 104 using any excess solar power. The power system 102 may recognize when it is likely to obtain energy, for example it recognizes that it will only receive energy from an auxiliary solar panel 142 of the home 104 during the daylight hours and may charge the RV battery module 162 or provide excess solar power to the home 104 as the case may be.

In another scenario where the user does not enter desired SOC or a period of time that the RV 106 will be parked at the home 104, the power system 102 may be programmed to provide solar power to the home 104 by default, and use any extra solar power to charge the RV battery module 162. As another option, the power system 102 may be programmed to charge the RV battery module 162 to a threshold SOC by default, and send any extra solar power to the home 104 when the RV battery module 162 is at the threshold SOC.

When the RV battery module 162 is already above the threshold the power system can provide solar power to the home 104. When the power needs of the home 104 exceed what is generated by the auxiliary solar panel 142 (alone or in combination with the RV solar panel 140), the RV 106 supplements power generated by solar with power from the RV battery module 162. However, the RV 106 does not supplement power to the home 104 if doing so would cause the RV battery module 162 to go below the desired or threshold SOC.

The PCU 152 is a multi-functional power unit that provides all of the RV's power needs. The PCU 152 both receives input power from various sources, and converts and conditions power for both use by the RV 106 as well as by the home 104 when in a backup mode. Thus, all power requirements are provided in a single package having a short height (e.g., 19 inches). The compact nature of the PCU 152 allows power components such as inverters and rectifiers/chargers to be located in unique locations within the RV 106, such as under a bed or under the floor. Thus, the PCU 152 frees up storage and living space within the RV 106. Traditional power components such as inverters and rectifiers/chargers are large and bulky, and cannot be stored in locations such as under a bed.

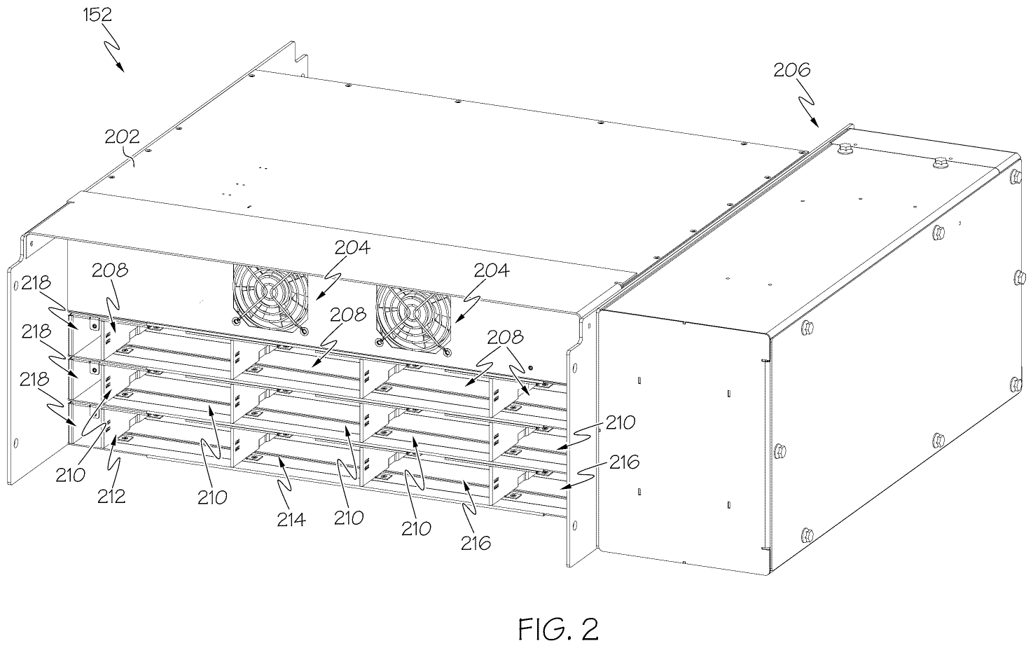

Referring now to FIG. 2, the PCU 152 includes a housing 202 having a plurality of slots for receiving modules having different functions. In the illustrated embodiment, the PCU 152 has four inverter slots 208, four rectifier slots 210 (also referred to as charger slots), two solar charger slots 216, one 12 VDC converter slot 214 and one miscellaneous slot 212 (also referred to as an empty slot). The example PCU has three rows of four slots each; however, additional or fewer rows and slots per row may be provided. As a non-limiting example, each slot opening may be approximately 130 mm wide by 45 mm tall.

Each slot is keyed to receive a particular modules, for example a solar charger slot 216 is keyed to only receive a solar module 154, an inverter slot 208 is keyed to receive only an inverter module 156, a rectifier slot 210 is keyed to only receive a charger module 158, and a 12 VDC converter slot 214 is keyed to only receive a DC-DC converter module 160. The various modules may be swapped in and out of the housing of the PCU 152 to provide expanded and flexible functionality for the RV 106. For example, an RV owner may have increased power needs over the lifetime of the ownership of the RV 106 and may therefore purchase additional modules as needed (e.g., purchasing a solar module 154 when installing solar panels on the RV).

One or more fans 204 may be provided to cool the internal components of the PCU.

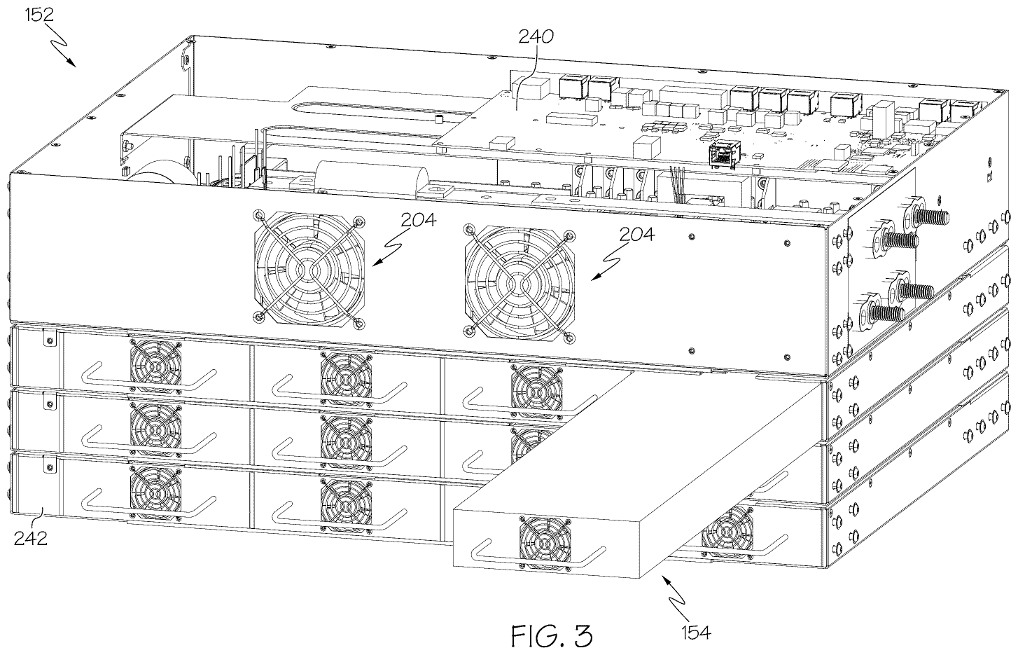

Referring now to FIG. 3, the PCU 152 is illustrated as being populated with the various modules in the various slots. The modules are easily slid in and out of respective slots. Tabs on either side of the slots may be pressed to unlock the module from the slot. In the example of FIG. 3, a solar module 154 is partially disposed within a solar charger slot 216.

Each module is designed for a particular output power level, such as, without limitation, 3.3 kW. The inverter module 156 includes electronic components capable of converting input DC power, such as DC power (e.g., 350 VDC, 400 VDC, 800 VDC, 1000 VDC) from the RV battery module 162, into a AC power for powering the RV 106 and/or the home 104 as needed. The inverter module 156 may include components such as metal-oxide-semiconductor field-effect transistors (MOSFETs), insulated-gate bi-polar transistors (IGBTs,) power transistors and the like to form an inverter circuit for converting DC voltage to AC voltage.

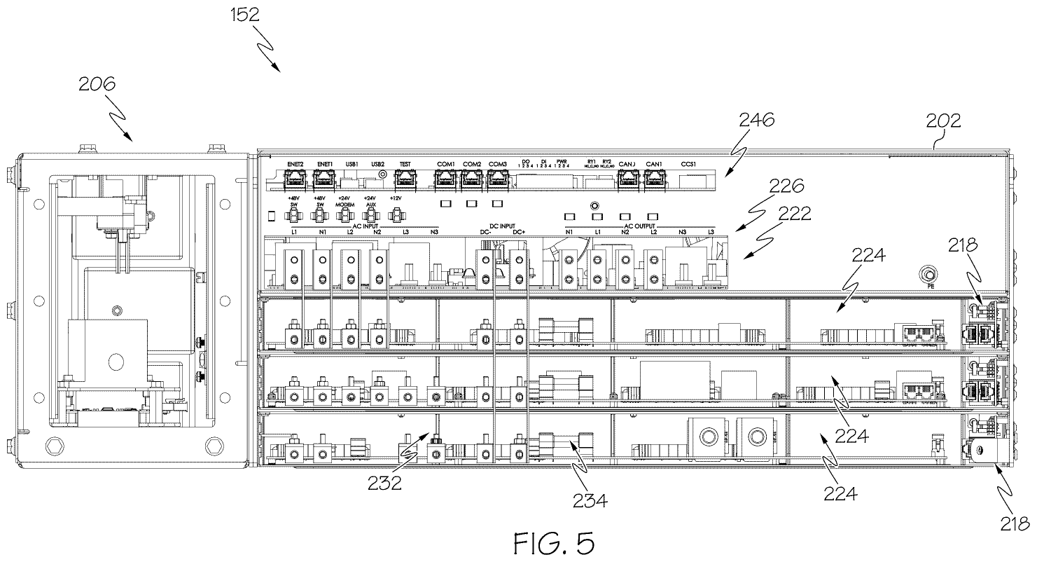

The charger module 158 includes electronic components defining a rectifier circuit that receives input AC power (e.g., from shore power) and converts it to DC power for charging the RV battery module 162. The DC-DC converter module 160 is operable to receive a DC input power (e.g., 350V from the RV battery module 162) and convert to another DC voltage, such as 12 VDC for use by RV DC loads 148 within the RV or other purposes. The solar module 154 receives input voltage generated by the RV solar panel 140 or the auxiliary solar panel 142, and includes circuitry to provide a voltage and current regulator for optimally charging the RV battery module 162. In some embodiments, the solar module 154 increases the DC voltage provided by the RV solar panel 140 or the auxiliary solar panel 142 and increases it to the voltage of the RV battery module 162, which may be, without limitation, 350V, 400V, 600V or 800V. This voltage may be provided on busbars 232 on the rear of the housing 202 (see FIG. 5).

Each module is self-contained and capable of performing its intended function. The PCU 152 gathers data from each of the installed modules and reports it to another computing device, such as a system control unit (SCU) (not shown). Referring to both FIG. 2 and FIG. 3, each row of the PCU 152 includes a controller port 218 operable to receive a controller module 242 that is responsible for communicating data and commands to and from the individual modules within the particular row. For example, the controller module 242 in the top-most row communicates with each of the inverter modules 156 installed in the top-row inverter slots 208. The controller module 242 may provide commands and/or data to the installed inverter modules 156. Likewise, the installed inverter modules 156 may provide commands and/or data to the controller module 242.

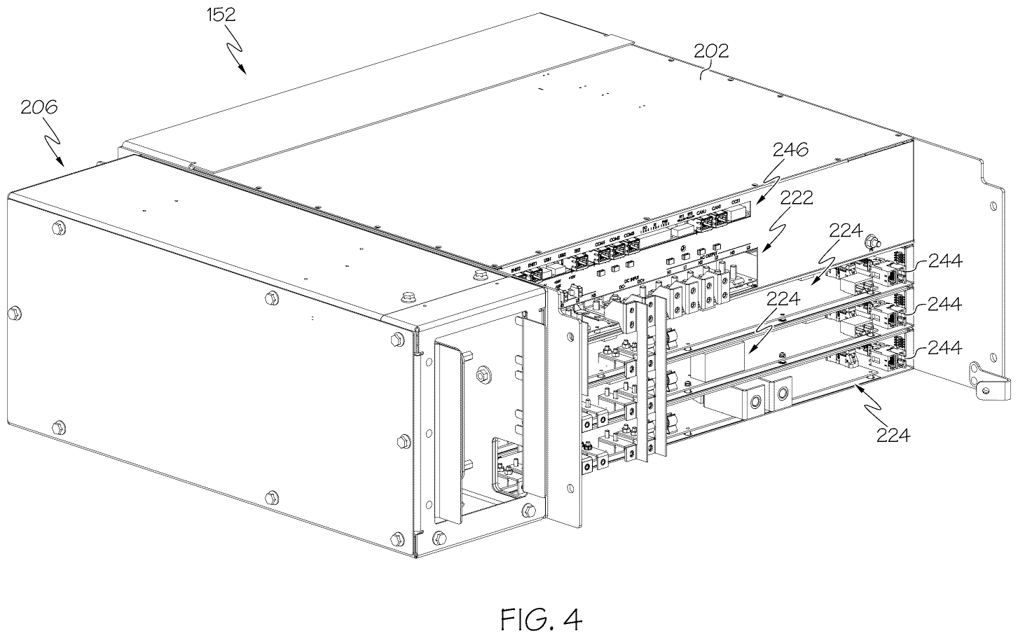

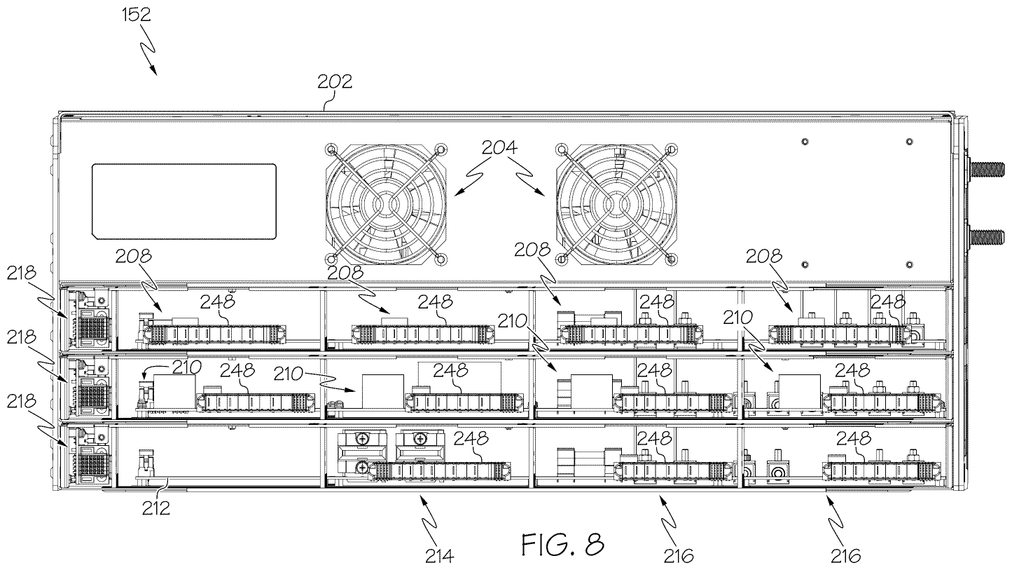

Referring now to FIG. 4, a rear perspective view of the PCU 152 is provided. The plurality of modules slots at the front of the PCU 152 terminate at a plurality of rear slots 224 at the rear of the PCU 152. The controller ports 218 terminate at a communication receptacle 244 that is operable to receive a communication cable to communicatively couple the controller module 242 to a main PCB 240 (FIG. 8).

The rear housing 202 of the PCU 152 includes various communication ports 246 as well as voltage input and output connections 222. The communication ports 246 may be used to communicate with other external components, such as the SCU, a vehicle control unit (VCU 174) of the vehicle towing the RV, or any other computing device or communication module. The voltage input and output connections 222 receive DC and AC input voltages from respective sources, as well as provide DC and AC output voltage to respective components. Fuses 234 may also be provided at the rear slots 224.

FIG. 5 illustrates a rear elevation view of the PCU 152. The communication ports 246 may include any type of receptacle including, without limitation, Ethernet ports, CAN ports, input/output ports for communicating with the charge port, and the like. These communication ports 246 may be provided on the main PCB 240, for example, and allow communication between the PCU 152 and the VCU 174. The main PCB 240 is responsible for interfacing between the controller modules 242 and external computing devices, such as the SCU. In addition, the main PCB 240 is responsible for ground fault protection and other functions.

The voltage input and output connections 222 include AC input connections for receiving wiring that provides AC power, such as shore power received from RV AC outlet receptacle 126. The voltage input and output connections 222 further includes DC input connections 228 for receiving wiring connected to the RV battery module 162. Busbars 232 are provided to connect different rows to the appropriate voltages.

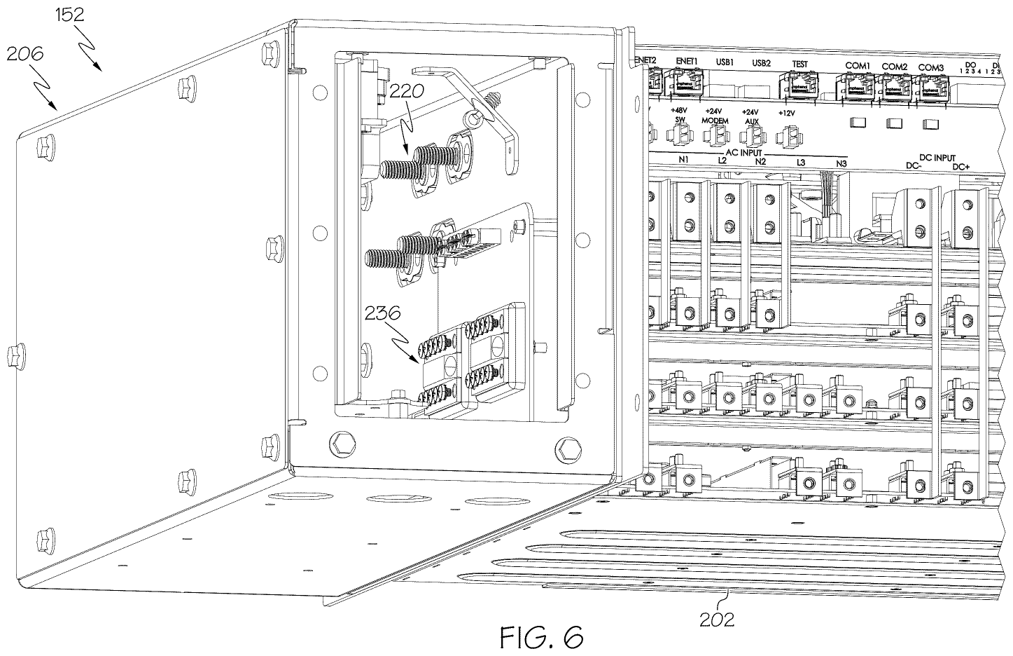

Referring to FIG. 6, the housing 202 is coupled to a terminal box 206 that provides an enclosure for making wiring connections to the components within the housing 202. The terminal box 206 includes one or more terminals 236 that receiving wiring for making electrical connections. The terminal box 206 protects the electrical connections. The terminal box 206 may also include other components such as current sensors, voltage sensors, fuses and the like. Battery connection terminals 220 extend through the housing 202 and into the terminal box 206 through openings. Wiring from the RV battery module 162 is connected to the PCU at the battery connection terminals.

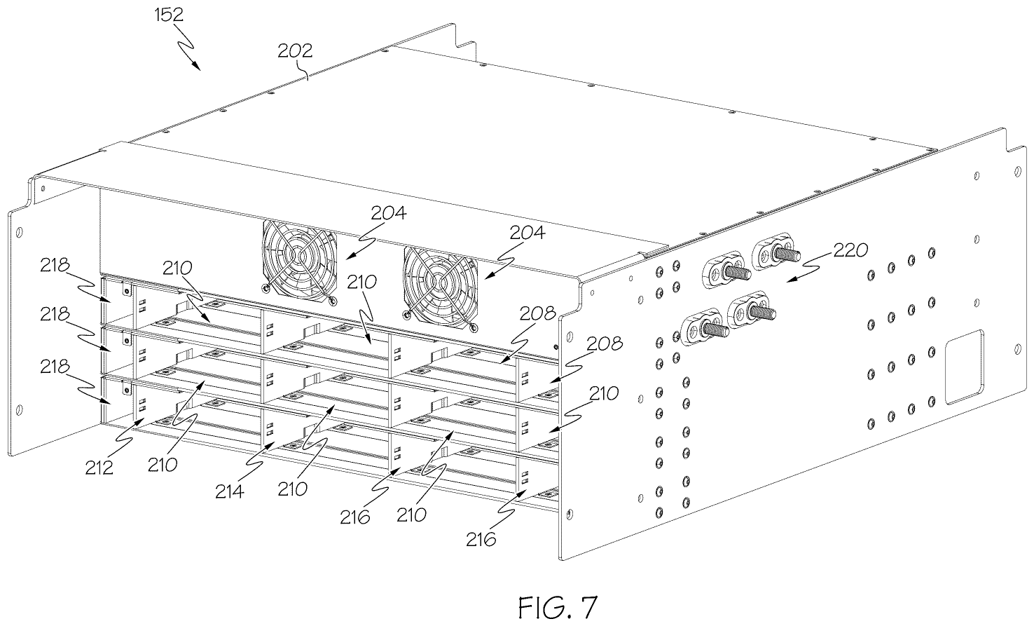

FIG. 7 illustrates a front perspective view of the PCU 152 with the terminal box 206 removed. The battery connection terminals 220 extend through a wall of the housing 202 to that they are accessible for electrical connection to RV battery module 162 wiring. In the illustrated embodiment, there are two pair of battery connection terminals 220. One pair is for connecting to the RV battery module 162 and the other pair is for connecting to DC pins of the bi-directional receptacle 130 (which provide the DC input from a Level 3 electric vehicle charger).

FIG. 8 illustrates a front view of the PCU 152. A keying feature 248 is provided within each slot (e.g., the inverter slots 208, the rectifier slots 210, the solar charger slots 216, and the 12 VDC converter slot 214. The keying feature 248 is operable to mate only with the appropriate type of module to prevent a wrong type of module from being inserted into a slot. For example, the keying features 248 may be configures as a series of ridges and grooves within the slots that only allow one type of power module to be inserted. The keying features 248 may also have electrical connections such that the inserted modules electrically mate with the keying features 248 within the slots.

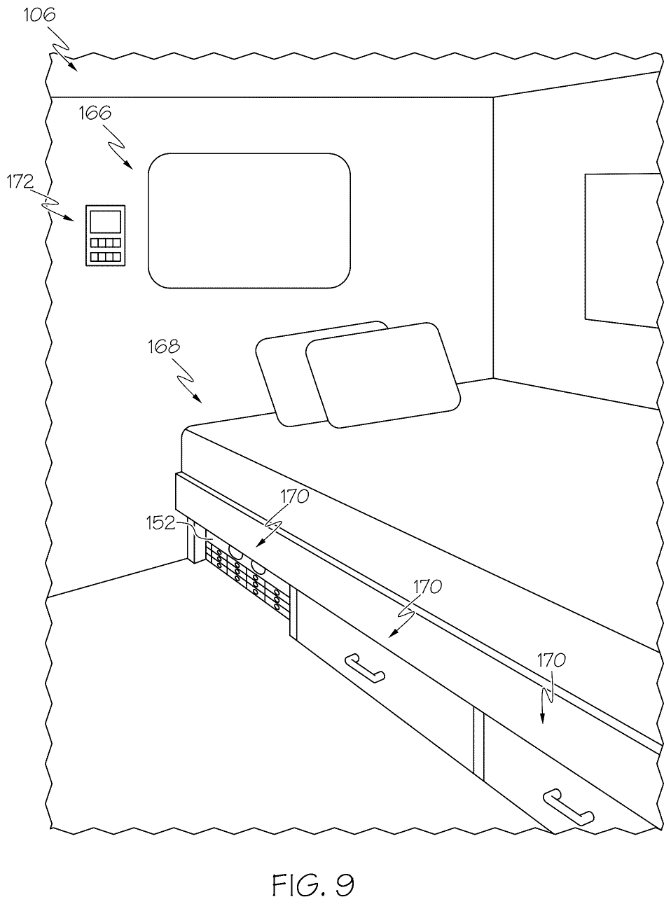

Referring now to FIG. 9, the compact design of the power conversion unit 152, with all of its centrally stored power modules, enables it to be located in convenient locations in the RV 106. Previous solutions required the separate and distinct inverters, converters to be located at inconvenient locations, such as external to the living space, in large utility closets or hatches that take up too much livable space, or inconveniently in the floor, which may be difficult to access.

A living space 166 of the RV 106 shown in FIG. 9 includes a bed 168 that defines a plurality of cubbies 170 between it and the floor. Storage solutions, such as drawers may be provided in the cubbies 170. In the embodiment of FIG. 9, the compact design of the power conversion unit 152 enables it to be mounted to the floor in one of the cubbies. The location of the power conversion unit 152 provides easy access to the power modules, which may be removed and added on-demand. In some embodiments, a decorative panel may be provided to conceal the power conversion unit 152. For example, the decorative panel may have a design that matches a front face of the drawers. It should be understood that the design and arrangement shown in FIG. 9 is for illustrative purposes only, and that the power conversion unit 152 may be located at any location within the RV 106.

Although embodiments are described herein as a single PCU 152 housing individual power modules in slots, embodiments are not limited thereto. The functionalities described herein, such as bi-directional power functions, may be performed by separate power modules that are not provided in a single housing, such as an individual charger module, an individual inverter, an individual solar module, and/or an individual DC-DC converter.

The PCU 152 provides advanced functionalities for power consumption and generation for an RV. In some embodiments, the voltage and frequency of AC power (i.e., shore power) is detected by the main PCB 240 and the voltage and frequency is then presented to the user in a user interface for confirmation. For example, the voltage may be 120 VAC or 240 VAC and the frequency may be 60 Hz or 50 Hz. The modules and the components of the PCU 152 can handle different input voltages and frequencies. The PCU 152 may report the detected input voltage and frequency to another computing device so that the confirmation request can be presented on a graphical user interface.

In one example, the input voltage and frequency is communicated to a VCU 174, which then provides it to a SCU 172. The SCU 172 may have a digital display that is capable of presenting the input voltage and frequency and requesting confirmation from the user. As another example, the SCU may by connected to the Internet such that the user may receive the input voltage and frequency in an application on a mobile device owned by the user. The user may use the mobile application or the display of the SCU 172 to confirm the input voltage and frequency. The user may also use the mobile application or display of the SCU 172 to create a default input voltage and frequency. In some embodiments, the PCU 152 may be automatically programmed to detect the input voltage and frequency and then automatically configure itself for the detected input voltage and frequency. The SCU 172 may also enable the user to select how long the RV will be in storage, which can dictate how often the RV 106 will wake from a sleep state, and also the charge and discharge schedule of the RV battery module 162 while the RV 106 is in storage. The SCU 172 may also send the user warnings and notifications, such as when the RV 106 is in storage.

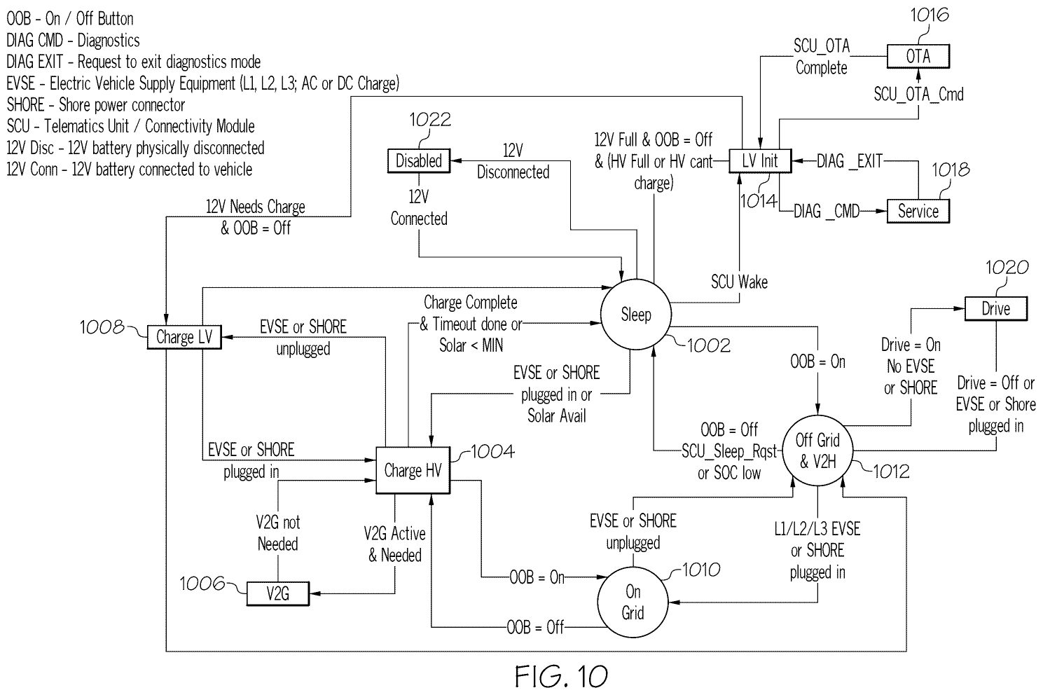

As stated above, the RV 106 is operable to perform multiple charging and discharging functionalities. For example, the high voltage RV battery module 162 may be used to power RV 106 components, to provide power to the grid 108, to provide power to a home 104, provide power to external loads, as well as receive power from one or more solar panels 110, 140, receive power from the grid 108, and receive power from a bi-directional connector 122 (see FIG. 1). FIG. 10 is a state diagram illustrating a plurality of possible states for the RV 106, as well as the conditions for transitioning between states.

At the sleep state 1002, the RV 106 is not taking any action and is awaiting further instructions or conditions. When the RV 106 is in the sleep state 1002 and the on-off button (OOB in FIG. 10) of the RV 106 is pressed on, the RV 106 transitions to the off grid and V2H state 1012. In this state, the electric vehicle supply equipment (EVSE) (e.g., L1, L2, L3 or AC or DC charge connectors (see the bi-directional connector 122 of FIG. 1 as an example)) and the shore power are disconnected from the RV 106 and the RV AC input receptacle 128 (i.e., shore power receptacle) are disconnected. During this state, the RV 106 is off grid and may power the RV load 134 using the RV battery module 162. The RV 106 may also provide electrical power from the RV battery module 162 to the home 104 by way of the RV AC outlet receptacle 126. In this condition, the bypass transfer switch 138 is set to connect the output of the RV battery module 162 to the RV AC outlet receptacle 126. At the home side, the home transfer switch 124 is operable to electrically couple the home AC input receptacle 118 to the panel 110.

When the RV 106 is being driven (e.g., an ignition of a motor home RV or detection of movement of a trailer RV), the RV 106 transitions to the drive state. The RV 106 exits the drive state when drive is off (or otherwise an indication that the RV is not being driven or towed), the RV 106 transitions back to the off grid and V2H state 1012.

The RV 106 may further exit the off grid and V2H state 1012 when the on-off button is switched to off, the SCU 172 initiates a sleep command, or the state of charge of the RV battery module 162 is low. In these situations, the RV 106 enters the sleep state 1002, where it may then transition into a different state depending on the situation.

The RV 106 also transitions out of the off grid and V2H state 1012 when the EVSE is connected to the RV bi-directional receptacle 130 or shore power is connected to the RV AC input receptacle 128. In this case, the RV 106 transitions to the on grid state 1010, which is described in more detail below.

When the RV 106 is in the sleep state 1002 and the electric vehicle supply equipment is plugged in (i.e., the bi-directional connector 122), there is shore power available, or there is solar power available from one or more solar panels 140, 142, the RV 106 may transition to the charge HV state 1004 where at least one of the aforementioned power sources charge the high voltage RV battery module 162. The RV battery module 162 includes a battery management system (BMS) that monitors the state of charge of the energy storage cells of the RV battery module 162 and controls when and how the RV battery module 162 is charged. When the RV battery module 162 is fully charged, or there is a fault, the BMS reports the full charge status or fault and charging ceases. When charging ceases, or there is no longer electrical power being applied to the RV battery module 162, the RV 106 transitions back to the sleep state 1002.

When the RV 106 is in the charge HV state 1004 and the on-off switch is set to on, the RV 106 transitions to the on grid state 1010. In this state, the RV loads 134 are electrically powered by the grid 108. When the on-off button is switched off, the RV 106 transitions back to the charge HV state 1004, where the RV battery module 162 is charged if needed. If the RV 106 is disconnected from the grid 108 either through the EVSE equipment at RV bi-directional receptacle 130 or at RV AC input receptacle 128, the RV 106 transitions back to the off grid and V2H state 1012 where the vehicle is operable to power the RV loads 134 using the RV battery module 162 and/or provide electrical power to the home 104.

The RV 106 may also operate in a vehicle to grid state 1006 whereby the RV battery module 162, in conjunction with the PCU 152, provides AC electrical power to the grid 108 through the RV AC outlet receptacle 126. This mode may be desirable to provide excess electricity generated by one or more of the RV solar panel 140 and the auxiliary solar panel 142. The solar power generated by the panels can be provided to the RV battery module 162 through the PCU 152, which than uses the inverter module 156 to produce AC power that can be provided to the RV AC outlet receptacle 126. When a vehicle to grid mode is active and power on the grid 108 is needed (e.g., by a control signal received from the home or from a utility component), the RV 106 transitions to the vehicle to grid state 1006 such that the AC power generated by the inverter module 156. When vehicle-to-grid power is no longer needed, the RV 106 transitions back to the charge HV state 1004 whereby the RV battery module 162 is charged.

When the EVSE is unplugged from RV bi-directional receptacle 130 or shore power is unplugged from RV AC input receptacle 128, the RV 106 transitions to the charge LV state 1008 where the RV battery module 162 charges the low voltage battery (12 VDC battery) of the RV 106. Shore power charges the RV 106 when shore power is received by the RV 106. When the EVSE is plugged into the RV bi-directional receptacle 130 or shore power is received at RV AC input receptacle 128, the RV 106 transitions back to the charge HV state 1004.

When the low voltage battery is fully charged or the voltage of the RV battery module 162 is too low and the on-off button is off, the RV 106 transitions to the sleep state 1002.

When the RV 106 is in the sleep state 1002 and the low voltage battery (12 VDC battery) is disconnected, the RV 106 transitions to the disabled state 1022. In this state, the RV 106 cannot drive, produce power, receive power, or operate electrical equipment. When the low voltage battery is connected again, the RV 106 transitions back to the sleep state 1002.

The RV 106 may also exit the sleep state 1002 state when there is a request from a controller, such as a VCU 174 or a SCU 172. For example, the controller may request that the RV 106 wake up such that the RV 106 enters the LV initiation state 1014. In the LV initiation state 1014, the charge level of the low voltage may be determined. When the low voltage battery needs charging (i.e., its state of charge is below a threshold) and the on-off button is off, the RV 106 transitions to the charge LV state 1008, where the low voltage battery is charged. The VCU 174 and/or the SCU 172 may periodically wake the RV 106 from the sleep state 1002 to check the state of charge of the low voltage battery.

Additionally, the RV 106 may exit the LV initiation state 1014 when a controller needs to perform an update, such as when the SCU 172 needs to complete an update. In this case, the SCU 172 may send an over-the-air command to transition the RV 106 to the OTA state 1016, where update software is downloaded by a communications network, such as a cellular or other wireless or wired communication network, and installed. When the over-the-air update is complete, the RV 106 transitions back to the LV initiation state 1014. The RV 106 transitions back to the sleep state 1002 when the low voltage battery is fully charged, the on-off button is off and the RV battery module 162 is fully charged.

The RV 106 can also transition out of the LV initiation state 1014 to enter a service state 1018 when a diagnostic command is received. In the service state 1018, the RV 106 may perform diagnostics and/or a technician may perform service and/or diagnostics.

The PCU 152 provides advanced functionalities for power consumption and generation for an RV. In some embodiments, the voltage and frequency of AC power (i.e., shore power) is detected by the main PCB 240 and the voltage and frequency is then presented to the user in a user interface for confirmation. For example, the voltage may be 120 VAC or 240 VAC and the frequency may be 60 Hz or 50 Hz. The modules and the components of the PCU 152 can handle different input voltages and frequencies. The PCU 152 may report the detected input voltage and frequency to another computing device so that the confirmation request can be presented on a graphical user interface. In one example, the input voltage and frequency is communicated to a VCU 174, which then provides it to a SCU. The SCU may have a digital display that is capable of presenting the input voltage and frequency and requesting confirmation from the user. As another example, the SCU may by connected to the Internet such that the user may receive the input voltage and frequency in an application on a mobile device owned by the user. The user may use the mobile application or the display of the SCU to confirm the input voltage and frequency. The user may also use the mobile application or display of the SCU to create a default input voltage and frequency. In some embodiments, the PCU 152 may be automatically programmed to detect the input voltage and frequency and then automatically configure itself for the detected input voltage and frequency.

It should now be understood that embodiments of the present disclosure are directed to PCUs that include slots for receiving multiple modules having different power functions. The PCUs described herein package inverter modules, charger modules, solar charger modules, and DC-DC converter modules all into one single package. This compact and multi-functional package can save significant space, and be located within desirable locations of an RV, such as under a bed or under the floor. The modular nature of the PCUs described herein allow an RV owner to expand the power functionalities and capabilities of the RV as needs change. For example, an RV owner may later decide to add solar panels to the RV and may then simply buy a solar module that he or she slides into the solar charger slot of the PCU. Additionally, the RV may be used to provide bi-directional charging and powering capabilities. Power may be provided by the RV to power a home or return electrical energy from to the grid.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

1. A recreational vehicle (RV) comprising:
an RV battery module that provides a direct current (DC) voltage of 400 volts or greater;
an RV alternating current (AC) input receptacle for receiving AC voltage from an external source;
an RV AC outlet receptacle for providing AC voltage to one or more of a grid and a building;
an RV bi-directional receptacle for receiving voltage from the external source and providing voltage to an external load; and
a power conversion unit, wherein:
the RV battery module is charged by the power conversion unit when:
the RV battery module has a state of charge below a threshold and voltage is received at one or more of the RV AC input receptacle and the RV bi-directional receptacle; or
solar DC voltage is received at the power conversion unit;
AC voltage is provided at the RV AC outlet receptacle to power one or more of the grid and the building when:
the RV battery module has a state of charge above a threshold and voltage is received at one or more of the RV AC input receptacle and the RV bi-directional receptacle; or
solar DC voltage is received at the power conversion unit; and
AC voltage is provided at the RV AC outlet receptacle to power the building when the RV battery module has a state of charge above a threshold and no voltage is received at the RV AC input receptacle or the RV bi-directional receptacle.

2. The RV of claim 1, wherein the power conversion unit comprises a housing enclosing a plurality of slots operable to removably receive a plurality of power modules, wherein the plurality of power modules comprises:
a solar module operable to receive DC voltage from one or more solar panels and convert the DC voltage to a second DC voltage,
a charger module operable to convert AC voltage into DC voltage to charge the RV battery module, and
an inverter module operable to convert DC voltage provided by the RV battery module into AC voltage that powers one or more RV AC loads and is provided at one or more of the RV AC outlet receptacle and the RV bi-directional receptacle.

3. The RV of claim 2, wherein each slot of the plurality of slots is operable to receive one type of the solar module, the charger module, and the inverter module.

4. The RV of claim 2, further comprising one or more controller modules, each controller module being operable to be communicatively coupled to a subset of the plurality of power modules.

5. The RV of claim 4, further comprising a main printed circuit board communicatively coupled to the one or more controller modules.

6. The RV of claim 1, wherein AC voltage is provided at the RV AC outlet receptacle to power the building when a request is received.

7. The RV of claim 6, wherein the request is in the form of an on-off button being set in an on position.

8. The RV of claim 1, wherein the one or more solar panels comprises one or more solar panels attached to a roof of the RV.

9. The RV of claim 1, wherein the one or more solar panels comprises at least one auxiliary solar panels remote from the RV.

10. The RV of claim 9, wherein the power conversion unit is operable to provide AC voltage to the building by receiving solar DC voltage generated by the one or more auxiliary solar panels.

11. The RV of claim 1, further comprising a low voltage battery having an output voltage that is lower than an output voltage of the RV battery module.

12. The RV of claim 11, wherein the power conversion unit comprises a DC-DC converter module for converting DC voltage provided by the RV battery module into an operating DC voltage for powering one or more DC loads.

13. The RV of claim 12, wherein the operating DC voltage of the DC-DC converter module is operable to charge the low voltage battery.

14. The RV of claim 1, further comprising a system control unit communicatively coupled to the power conversion unit, wherein the system control unit is operable to provide operating parameters to the power conversion unit.

15. The RV of claim 1, wherein the power conversion unit further comprises:
a housing;
a plurality of battery connection terminals for electrically coupling the power conversion unit to the RV battery module; and
a terminal box coupled to the housing such that the terminal box at least partially covers the plurality of battery connection terminals.

16. A recreational vehicle (RV) comprising:
an RV battery module;
a solar module operable to receive DC voltage from one or more solar panels and convert the DC voltage to a second DC voltage;
a charger module operable to convert AC voltage into DC voltage to charge the RV battery module; and
an inverter module operable to convert DC voltage provided by the RV battery module into AC voltage that powers one or more RV AC loads;
wherein:
the charger module is operable to charge the RV battery module of the RV when:
the RV battery module has a state of charge below a threshold and AC voltage is received by the charger module; or
DC voltage is received at the solar module;
AC voltage is provided by the inverter module to power one or more of a grid and a building when:
the RV battery module has a state of charge above a threshold and AC voltage is received at the charger module; or
DC voltage is received at the solar module; and
AC voltage is provided by the inverter module to power the building when the RV battery module has a state of charge above a threshold and no voltage is received by the charger module.

17. The RV of claim 16, wherein AC voltage is provided to power the building when a request is received.

18. The RV of claim 17, wherein the request is in the form of an on-off button being set in an on position.

19. The RV of claim 16, wherein the one or more solar panels comprises at least one auxiliary solar panels remote from the RV.

20. The RV of claim 19, wherein the one or more solar panels comprises one or more solar panels attached to a roof of the RV.
